(19) United States
(12) Patent Application Publication
(10) Pub. No.: US 2015/0026158 A1
(43) Pub. Date: Jan. 22, 2015

(54) SYSTEMS, METHODS, AND SOFTWARE FOR UNIFIED ANALYTICS ENVIRONMENTS

(71) Applicant: Kent State University, Kent, OH (US)

(72) Inventor: Ruoming Jin, Streetsboro, OH (US)

(21) Appl. No.: 14/375,876

(22) PCT Filed: Jan. 30, 2013
(86) PCT No.: PCT/US13/23804

§ 371 Date: Jul. 31, 2014

Related U.S. Application Data
(60) Provisional application No. 61/592,710, filed on Jan. 31, 2012.

(51) Int. Cl. G06F 17/30

(52) U.S. Cl. CPC G06F 17/30958; G06F 17/30979
USPC 707/722; 707/769

(57) ABSTRACT

Embodiments disclosed herein provide systems and methods for a unified analytics environment. In a particular embodiment, a method provides, handling a plurality of relational functions within a relational analytics environment. The method further provides, while handling the plurality of relational functions, encountering at least one graph function that comprises a query intended for a graph analytics environment. The method further provides, in response to encountering the at least one graph function, communicating with the graph analytics environment to handle the at least one graph function.

### RELATED APPLICATIONS

This application hereby claims the benefit of and priority to U.S. Provisional Patent Application 61/592,710, titled “METHOD FOR DATA ACQUISITION, INPUT, ANALYSIS, QUERY, AND RETRIEVAL WITH MASSIVE GRAPHS”, filed Jan. 31, 2012, and which is hereby incorporated by reference in its entirety.

### TECHNICAL BACKGROUND

A relational database system is a collection of data items organized as a set of formally described tables from which data can be accessed. These relational databases can become enormous, and the response to any query of these databases may require accessing a multitude of databases, each of which may be partially responsive to the query.

Many relational databases, such as in social networks, grow rapidly as data changes with respect to participants and their various natures, features, qualities, and the like. Such a network may be represented by a massive graph, where nodes are connected by edges to other nodes, and both the nodes and edges represent associated relational data.

Previously, the searching of these graphs has been laborious, time consuming, and inordinately and exhaustively detailed, requiring the individual treatment and assessment of each of a multiplicity of nodes and edges. Thus, there is a need for a more effective, efficient, and inexpensive structure, technique, and methodology for undertaking a query in such graphs and networks.

### Overview

Embodiments disclosed herein provide systems and methods for facilitating a unified analytics environment. In a particular embodiment, a method provides handling a plurality of relational functions within a relational analytics environment. The method further provides, while handling the plurality of relational functions, encountering at least one graph function that comprises a query intended for a graph analytics environment. The method further provides, in response to encountering the at least one graph function, communicating with the graph analytics environment to handle the at least one graph function.

In an alternative embodiment, one or more computer readable media having instructions stored thereon that, when executed by a computing system, direct the computing system to at least initiate a communication with a graph analytics environment to resolve a query specified by a graph function encountered while handling a plurality of relational functions in a relational analytics environment, wherein the communication identifies which graph analytics function of a plurality of graph analytics functions available within the graph analytics environment to apply when resolving the query in the relational analytics environment. The instructions further direct the computing system to receive a response to the communication and integrate the response with at least one other response from at least one of the plurality of relational functions.

In an alternative embodiment, a method provides acquiring data regarding a plurality of data sources, graphing said data into a graph of relational data nodes and interconnecting data edges. The method further provides sectioning said graph into sub graphs, defining super nodes in relational interconnection with other super nodes, each said super node comprising a group of relational data nodes and interconnecting data edges. The method further provides searching said sub graphs for response to a first query, further searching relational data nodes and interconnecting data edges of sub-graphs responding to said first query for response to a second query, and acting upon responses received from said second query.

### BRIEF DESCRIPTION OF THE DRAWINGS

FIG. 1 illustrates a unified analytics environment according to one example.

FIG. 2 illustrates a method for operating a unified analytics environment according to one example.

FIG. 3 illustrates an overview of the operation of a unified analytics environment according to one example.

FIG. 4 illustrates a unified analytics computing system according to one example.

FIG. 5 illustrates an overview of SuperGraphSQL.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

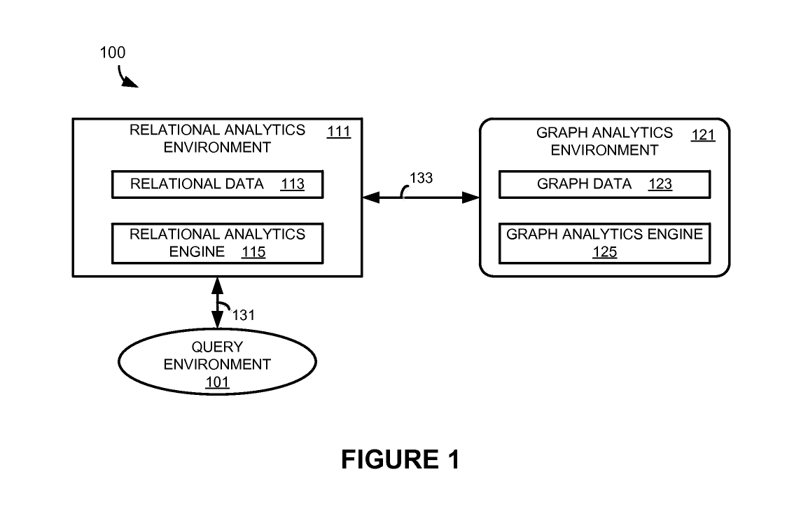

FIG. 1 illustrates a unified analytics environment 100 according to one example. Unified analytics environment 100 includes query environment 101, relational analytics environment 111, and graph analytics environment 121. Relational analytics environment 111 further includes relational data 113 and relational analytics engine 115. Graph analytics environment 121 further includes graph data 123 and graph analytics engine 125. Query environment 101 is configured to communicate with relational analytics environment 111 over communication link 131, and relational analytics environment 111 is further configured to communicate with graph analytics environment 121 over communication link 133.

Query environment 101 comprises one or more computer systems configured to query relational data 113 in relational analytics environment 111. Examples of query environment 101 can include desktop computers, laptop computers, or any other like device.

Relational analytics environment 111 comprises one or more computer systems configured to analyze, in response to an inquiry from query environment 101, relational data 113 using relational analytics engine 115. Relational analytics environment 111 is further configured to identify graph functions within the inquiry from query environment 101, and communicate these graph functions to graph analytics environment 121. In some examples, relational analytics environment 111 may represent a relational database management system or RDBMS. Relational analytics environment 111 can include server computers, desktop computers, laptop computers, or any other similar device—including combinations thereof.

Graph analytics environment 121 comprises one or more computer systems configured to store graph data 123, and to analyze graph data 123 using graph analytics engine 125. Graph analytics environment 121 can be configured to respond to graph function requests communicated from relational analytics environment 111. Graph analytics environment 121 can include server computers, desktop computers, laptop computers, or any other similar device—including combinations thereof.

Communication links 131 and 133 use metal, glass, air, space, or some other material as the transport media. Communication links 131 and 133 may use various communication protocols, such as Internet Protocol (IP), Ethernet, communication signaling or any other communication format—including combinations thereof.

Although query environment 101, relational analytics environment 111, and graph analytics environment 121 are illustrated as separate environments, unified analytics environment 100 may be implemented in any number of environments, and may be implemented using any number of computing systems.

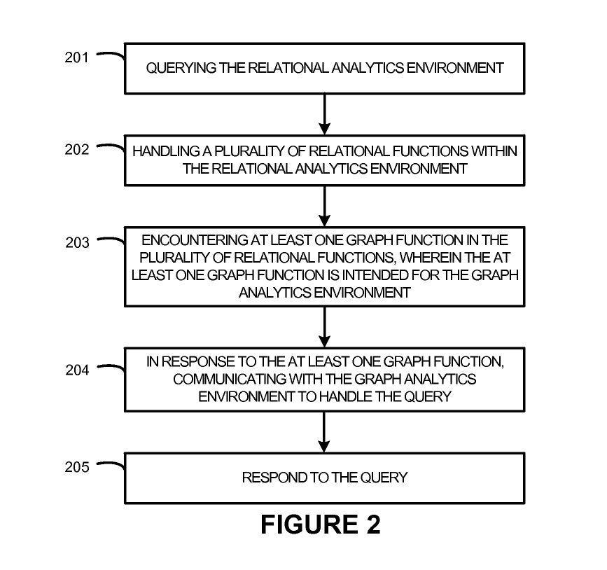

FIG. 2 illustrates a method for operating unified analytics environment 100 according to one example. In operation, query environment 101 will generate a query for relational analytics environment 111 (step 201). In some examples, the query will be formed in SQL (Structure Query Language) or more specifically SuperGraphSQL, which includes relational functions capable of interacting with relational data 113 and graph data 123. Such relational functions can include a ShortestPath function designed to find the shortest path between one item in relational data 113 to another data item in relational data 113. For example, if relational data 113 included information about flights, a query may include a function that asked for the shortest path between Cleveland, Ohio and Athens, Greece.

Following the inquiry by query environment 101, relational analytics environment 111 will handle the plurality of relational functions using relational analytics engine 115 (step 202). Some of these functions may include creating graphs from relational data 113, accessing previously created graphs, or any other relational functions. Some of the relational functions may also include graph functions that interact with the created or previously stored graphs, such as the ShortestPath function. These graph functions will be identified for graph analytics environment 121 by relational analytics environment 111 (step 203). In some examples, the graph functions may be user defined functions, which are created by the user in query environment 101.

Following the identification of a graph function, relational analytics environment 111 will communicate with graph analytics environment 121 to handle the graph function (step 204). For example, relational analytics environment 111 may communicate a ShortestPath function to graph analytics environment 121. Graph analytics environment 121 will then process the functions using graph data 123 derived from relational data 113. In the ShortestPath function example, graph analytics environment 121 will determine the shortest path between two items located in graph data 123.

Following the execution of the graph functions in graph analytics environment 121, a result will be generated for the function. In at least one example, graph analytics environment 121 will return the graph function result to relational analytics environment 111. The graph function result may then be integrated into a table with other responses to the relational functions. Finally, a result will may be transmitted to query environment 101 as a response to the original query (step 205).

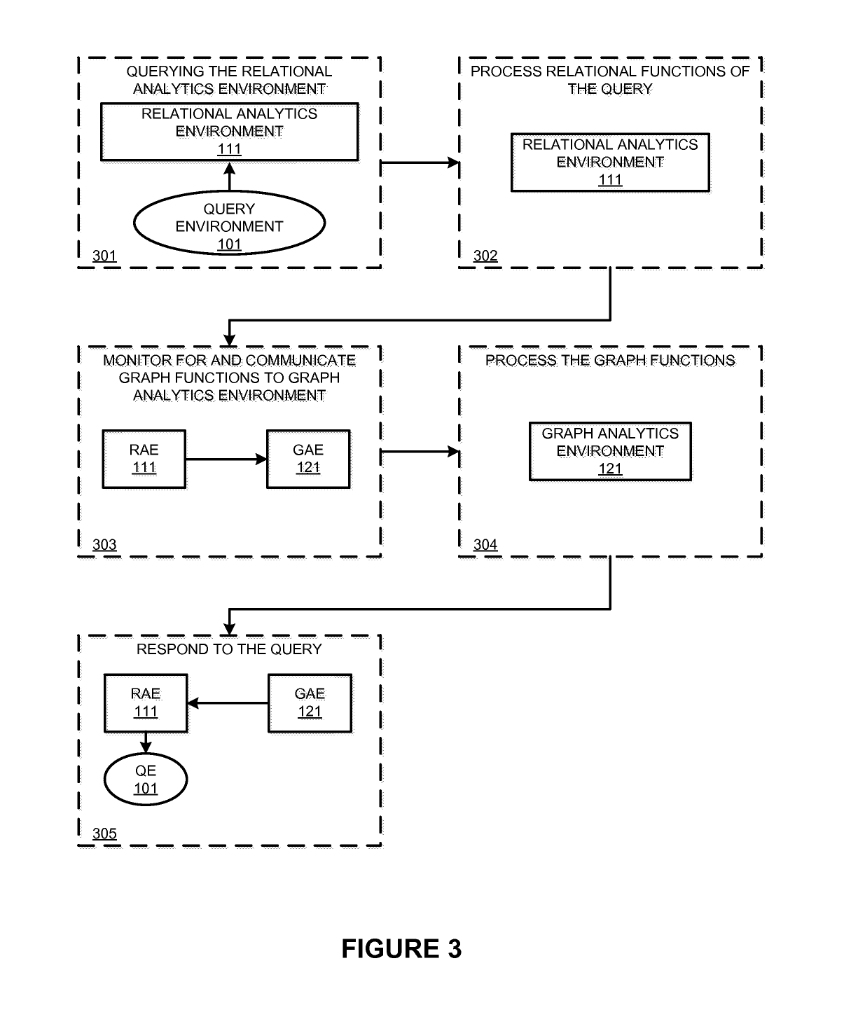

FIG. 3 illustrates an overview of the operation of unified analytics environment 100 according to one example. In FIG. 3, the operation begins by communicating a query between query environment 101 and relational analytics environment 111 (step 301). Such a query may be in in SQL or, more specifically, SuperGraphSQL, and comprise relational functions about the data in relational analytics environment 111. Following this query to relational analytics environment 111, relational analytics environment 111 will process the relational functions of the query (step 302). Such processing may include creating graphs from the data in relational analytics environment 111, defining previously created graphs, or any other relational processing. During the processing, relational analytics environment 111 will monitor for graph functions within the relational functions. Such graph functions will then be communicated to graph analytics environment 121 (step 303).

In at least one example, a graph function may include a ShortestPath function. Such a function will determine the shortest path between one data item in relational analytics environment 111 to another data item in relational analytics environment 111. For example, if relational analytics environment 111 maintained data about flights between cities, then a ShortestPath function could determine the shortest number of flights to get from Cleveland, Ohio to Athens, Greece, or any other flight combination. A ShortestPath function may also include other limitations to determining the shortest path between two data items. Returning to the flight example, the ShortestPath function could include limitations about the number of connecting flights, an overall time for the trip, or any other limitation to the ShortestPath function.

Upon receipt of the graph function, graph analytics environment 121 will analyze the graphs and perform the desired function (step 304). Following the execution of the graph function, graph analytics environment 121 will return a graph function response to relational analytics environment 111. In at least one example, the graph function response may then be integrated into a table with other responses to the relational functions. Relational analytics environment 111 can then respond to the original query based, at least in part, on the response to the graph function (step 305).

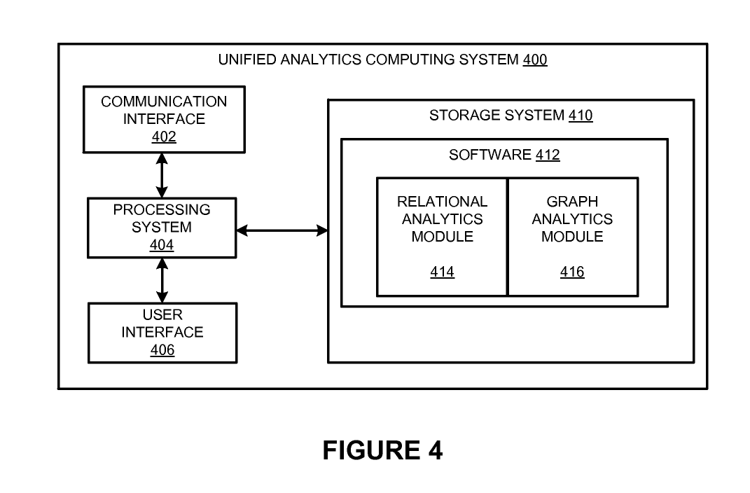

FIG. 4 illustrates a unified analytics computing system 400 according to one example. Unified analytics environment 400 includes communication interface 402, processing system 404, user interface 406, storage system 410, and software 412. Processing system 404 loads and executes software 412 from storage system 410. Software 412 includes relational analytics module 414 and graph analytics module 416. Software 412 may further include an operating system, utilities, drivers, network interfaces, applications, or some other type of software. When executed by unified analytics computing system 400, software modules 414 and 416 direct processing system 404 to operate as a relational analytics environment and graph analytics environment as described herein.

In particular, in at least one example, communication interface 402 is configured to receive a query from a query system. In some examples, the query may be in the form of SQL or SuperGraphSQL and include relational functions to be processed by unified analytics computing system 400. After the receipt of the query, relational analytics module 414 will process the relational functions and identify graph functions within the relational functions. These graph functions will then be communicated to graph analytics module 416 for processing. Following the completion of the processing, a response will be created using at least the graph function result and will be communicated to the query system using communication interface 402.

Although unified analytics computing system 400 includes two software modules in the present example, it should be understood that any number of modules could provide the same operation.

Additionally, computing system 400 includes communication interface 402 that can be configured to receive queries from any outside query source, and transfer a response back to the query source. Communication interface 402 can communicate using Internet Protocol (IP), Ethernet, communication signaling, or any other communication format.

Referring still to FIG. 4, processing system 404 can comprise a microprocessor and other circuitry that retrieves and executes software 412 from storage system 410. Processing system 404 can be implemented within a single processing device but can also be distributed across multiple processing devices or sub-systems that cooperate in executing program instructions. Examples of processing system 404 include general-purpose central processing units, application specific processors, and logic devices, as well as any other type of processing device, combinations of processing devices, or variations thereof.

Storage system 410 can comprise any storage media readable by processing system 404, and capable of storing software 412. Storage system 410 can include volatile and nonvolatile, removable and non-removable media implemented in any method or technology for storage of information, such as computer readable instructions, data structures, program modules, or other data. Storage system 410 can be implemented as a single storage device but may also be implemented across multiple storage devices or sub-systems. Storage system 410 can comprise additional elements, such as a controller, capable of communicating with processing system 404.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. It should be understood that in no case is the storage media a propagated signal.

User interface 406 can include a mouse, a keyboard, a camera, a voice input device, a touch input device for receiving a gesture from a user, a motion input device for detecting non-touch gestures and other motions by a user, and other comparable input devices and associated processing elements capable of receiving user input from a user. Output devices such as a graphical display, speakers, printer, haptic devices, and other types of output devices may also be included in user interface 406. The aforementioned user input and output devices are well known in the art and need not be discussed at length here. In some examples, user interface 406 can be omitted.

It should be understood that although unified analytics computing system 400 is illustrated as a single system for simplicity, the system can comprise one or more systems. For example, in some embodiments relational analytics module 414 and graph analytics module 416 may be divided into separate systems. In another example, unified analytics computing system 400 may further include a query module, which may create queries to be answered by relational analytics module 414 and graph analytics module 416.

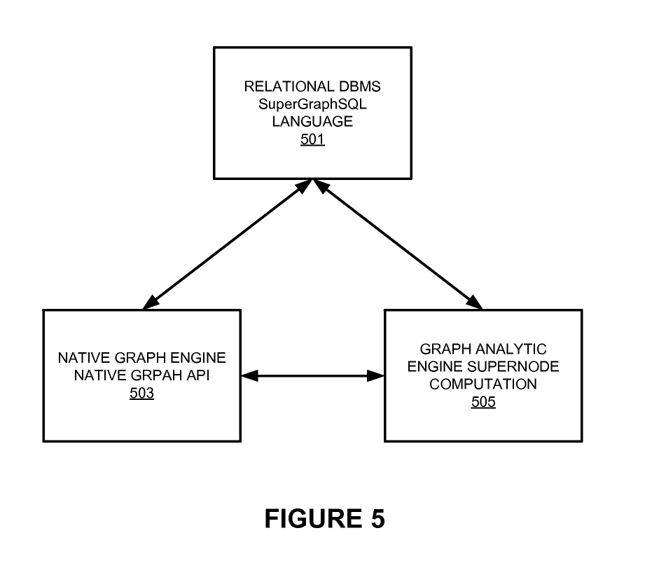

FIG. 5 illustrates an overview of SuperGraphSQL. SuperGraphSQL is a unified analytics platform for performing large scale relational and graph analytics. In FIG. 5, the relational Database Management System or DBMS uses the SuperGraphSQL language 501. This SuperGraphSQL language 501 can then communicate with Native Graph Engine 503 and Graph Analytic Engine 505. Furthermore, Native Graph Engine 503 can communicate with Graph Analytic Engine 505. These communication lines allow SuperGraphSQL to perform large-scale graph analytics.

In a particular example, the systems and environments of FIGS. 1-5 use a unified analytics platform for large scale relational and graph analytics called SuperGraphSQL. SuperGraphSQL runs on one or more computer nodes and is based on the shared-nothing/scale out principle. SuperGraphSQL has the following unique features:

1. It natively supports temporal graph analytics. Many graphs can grow, shrink and change over time, including people's social connections and a virus spreading on the internet. Answering questions on dynamic graphs using the time dimension can be easily expressed and answered in the SuperGraphSQL system. Some examples include: what the social graph looked like as of a year ago and what was the average shortest path between any two users; how many computers were affected by a particular computer virus in three days or thirty days since its discovery; how the retweeting graphs about a social event evolved over the last seven days.

2. It provides a unified SuperGraphSQL language to allow its users to create graph views over relational tables. Therefore, it provides users with the following innovative querying capabilities including: performing graph analytics over relational data; performing relational analytics over defined graphs; joining graphs with graphs; and joining relations and graphs.

3. It allows users to perform both relational and graph analytics over existing data stored in traditional relational DBMS through the same SuperGraphSQL language by streaming data from the other RDBMS.

4. It provides a native graph interface for third party clients to insert and store graph data in the SuperGraphSQL system. Users can then perform both relational and graph analytics over the graph data.

5. In addition to a large extensive built-in graph analytics functions, SuperGraphSQL provides an enhanced BSP node-centric programming model to allow users to easily write customized graph analytics functions. More specifically, users just need to provide a superstep function/class, which will perform computation on each node in a graph and send messages to other nodes. The SuperGraphSQL system will automatically and repeatedly perform the superstep computation on all nodes and take care of message passing/synchronization/failure handling/operation optimization. A fundamental aspect of the Bulk Synchronous Parallel model is the large amount of messaging passing on big graphs, which can become a performance problem. SuperGraphSQL employs a novel technique called SuperNode computation to optimize parallel synchronous computation for large-scale graph analytics.

6. SuperGraphSQL provides users the flexibility of having different hardware system configurations for running relational and graph analytics depending on users' workload and applications. The software architecture is the same. Some example hardware system configurations are shown below.

An exclusive subset of nodes in SuperGraphSQL system runs only relational analytics while all other nodes run only graph analytic functions. With this configuration, users can use more powerful computer nodes dedicated to graph analytics.

Both relational and graph analytics run on every computer in the SuperGraphSQL cluster.

Clearly, there is a great need to manage and analyze graph data in a simple yet efficient manner. Such a need gives rise to a fundamental challenge the database research community faces today: how to provide persistent storage and support graph operations in a database environment? To address this challenge, there are two major approaches: providing relational database support for graphs and native graph database.

Relational DBMS: The existing relational DBMS (DataBase Management System) can be employed to store graph data rather easily. For instance, the edge (link) information of the graph data can be, in general, represented through a three-column table (source, destination, label) in a relational database, similar to the triple-store [1, 5, 7, 13, 34] for RDF data. To support various graph queries/analytics in a relational DBMS, a few new operators, such as connect-by from Oracle and SQL standard's Common Table Expressions (CTEs), have been introduced to enable recursion through the vertices in graphs. However, it remains to be difficult in expressing complex graph queries in a relational DBMS. Specifically, 1) writing recursive queries in SQL is not very intuitive and these operators are not easy to use; 2) recursive queries for graphs are computationally expensive and difficult to scale to very large graphs with millions or even billions of vertices and edges; 3) these operations are too primitive and limited to develop more complex graph queries.

From the late 80s to the early 90s, there have been several proposals attempting to provide a unified graph database model and graph query language (based on relational model). The query supports target either graph-pattern matching (subgraph matching) or path-based queries, and often translate the graph queries into recursive queries. In other words, these graph database models are not capable of handling the general graph mining and graph analytics queries, which are essential for analyzing social networks and other complex networks. In addition, though these graph database models are theoretically sound, the efficiency and scalability of query processing are the main issue, as these general graph query classes are NP-hard and the recursive queries are computationally expensive.

Native Graph Database: Because of the difficulty in querying graphs in relational DBMS, there have been emerging interests in constructing native graph databases. Most of these efforts resonate with the “NoSQL” movement, and completely separate them from relational DBMS. Specifically, there are two types of graph databases in managing and analyzing graphs: native graph store and distributed graph processing engine. The native graph store provides persistent storage for graph data using its native format consisting of vertices, edges (relationships), and properties. They generally do not have a unified graph query language, but instead offer some basic graph operations, such as node/edge management and graph traversal supports, through a library API. Thus, theoretically, they are not complete database systems, but persistent graph data storage with low-level graph operation libraries.

Graph Query Examples

The logical model of graph data is rather simple and so is its physical storage. However, the graph operations are extremely diverse: ranging from adjacency queries, to reachability/path queries, to subgraph matching, to high level statistical calculation, to graph mining processing, etc. For instance, here are some queries a user can pose on the massive graph data:

1. Q1 (General Graph): Find Certain Type of Nodes (such as the orphan nodes or the nodes with highest degree);

2. Q2 (General Graph): Count the number of nodes whose degree is equal to 5;

3. Q3 (General Graph): Find the diameter of the graphs;

4. Q4 (Web Graph): Rank each webpage in the webgraph or each user in the twitter graph using PageRank, or other centrality measure.

5. Q5 (Transportation Network): Return the shortest or cheapest flight/road from one city to another;

6. Q6 (Social Network): Count the number of users in the social network who tweet at least five times a day;

7. Q7 (Social Network): Find all the other users in the social network a user can reach in 4 steps;

8. Q8 (Social Network): Determine whether there is a path less than 4 steps which connects two users in a social network;

9. Q9 (Social Network): Find the tweet has the longest retweet chain?

10. Q10 (Financial Network): Discover those sets of financial transactions which form a loop among the accounts involved in the transaction;

11. Q11 (Financial Network): Find the path connecting two suspicious transactions.

12. Q12 (Temporal Network): Compute the number of computers who were affected by a particular computer virus in three days, thirty days since its discovery;

13. Q13 (Temporal Network): Compute the difference between the average shortest path between any two users in the social network of this month against last month;

14. Q14 (Spatial Social Network): Calculate the correlation between physical distance and network distance between any users in a social network;

15. Q15 (Spatio-Temporal Network): Discover a group of suspects who have frequently communicated with each other in the last month and have at least met once in a location in this week;

The graph queries can be categorized according to different criteria. Note that different categorization does not only help in the understanding of the scope of graph queries, but also helps in understanding the underlying challenges of supporting them in a database environment. A particular important categorization is to consider a graph query to either belong to relational analytics or graph analytics.

A graph query is classified based on whether the queries involve graph traversal (self-join) or not. One may refer to the queries without the need of graph traversal as the relational analytics query and others as graph analytics or (recursive graph analytics). In earlier examples, except Q1, Q2, and Q6, all of other queries are recursive graph analytics. Indeed, many commonly used graph queries are inherent with the graph traversal nature.

Note that traditional relational database can easily store large graphs (vertices and edges). A parallel DBMS can store billions of edges and vertices without a problem. However, relational database is not designed to handle a large number of self-join (graph traversal) operations. Thus, any graph query that consists of graph traversal is generally difficult to execute and hard to describe in SQL. The existing DBMS query engine lacks the capabilities to perform efficient graph paralytics on the graphs stored in SQL tables. Below, a simple example is illustrated (the query is an instance of Q5). Assume an airline has the following flights table:
Flights(flight_number,departure_city, arrival_city,price,airline_name)

Now, consider a user wants to find the cheapest flight from Cleveland to Athens with a maximum of three stops. Based on SQL, the query has to consist of recursion and table self-join operations. Such an operation becomes cumbersome, especially if the limitation on the number of stops is dropped and the route is simply the cheapest flight from Cleveland to Athens.

To meet the challenges of handling the graph queries SuperGraphSQL is introduced, which contains a language and system to seamlessly integrate SQL and graph processing. Furthermore, the graph-processing model in SuperGraphSQL is based on BSP (Bulk Synchronous Parallel) programming model. Thus, SuperGraphSQL not only provides the leverage of the powerful parallelism for scaling massive graph processing, but also is the first system that supports SQL relational engine to access BSP. SuperGraphSQL is both a relational DBMS and a graph DBMS, and marry these two in a seamless fashion: there is no explicit data movement needed between two independent systems (a relational DBMS and a graph DBMS), more importantly, the relational query and graph analytic query can be combined in any sequential and/or nested way intuitively.

SuperGraphSQL enables the following features: 1) any relational table to be directly viewed as a graph (as long as the appropriate key/foreign-key mapping exists) and thus any graph analytic query can be applied to the relational tables directly; 2) any graph can be managed and queried as relational tables; 3) any result produced from graph (relational) queries can be further queried as relational tables or as graphs, and thus the graph query and relational query can be combined in any way to any nested level. In other words, SuperGraphSQL enables the graphs and relational tables to be managed and queries in a uniform fashion, and maximize the capabilities of relational DBMS and graph analytics processing engine. Note that in the existing relational DBMS, there are no explicit graph definitions (only relations or tables); and in the native graph database, there are no explicit relation definitions (only graphs). SuperGraphSQL thus significantly expands the capabilities of relational DBMS and native graph databases. It is even more powerful than their added capabilities.

Relational Analytics and Graph Analytics: SuperGraphSQL includes a powerful parallel graph processing engine which consists of not only built-in graph analytic functions (such as graph traversal, path discovery, sub-graph match, and various graph mining capabilities), but also offers powerful primitives and libraries to develop any additional user-desired graph analytic function (The detailed discuss of graph processing is in next section). The graph-processing engine utilizes BSP model and can leverage shared-nothing clusters, shared-memory multi-core computers, and their combination (clusters of multi-core computers). Importantly, not only explicitly defined graphs but also relations (with appropriate key/foreign-key relationship) can both be directly queried using the graph processing engine and the queried results are represented as relations (or graphs). Furthermore, any graph has an inherent relational view, which enables any relational analytics (or relational queries) to be queried on graphs.

Join between Graphs and Relations: Join operator plays a center role in the traditional relational DBMS as it allows to link different tables in a unified fashion. Indeed, it is a major difference between the relational DBMS and the latest NoSQL movement which includes the native graph database projects. Since any graph has an inherent relational view, SuperGraphSQL can easily support the powerful join operators between relations, between graphs and relations, and even between graphs.

Temporal, Spatial, and Spatio-Temporal Graphs and Graph Analytics: Most of the graphs are not statics; they grow, shrink, and change over the time. The representative ones include social network, financial markets, virus spreading over Internet, etc. SuperGraphSQL natively supports model, storage, and query on the temporal graphs. Specifically, SuperGraphSQL associates any node and any edge in a graph with a “valid-time” interval, and introduces keyword to allow access to a graph at any user-desired interval. Similarly, many (social) networks are associated with location information, i.e., a user can check-in certain locations and two people can meet at a location. These spatial networks can be further integrated with temporal dimension to produce spatio-temporal graphs. SuperGraphSQL leverages the spatial data support from the relational database and provides native support of these graphs as well.

Mathematically, a graph data set can be simply represented as a directed labeled graph G—(V,E,Lv,Le), where V is the vertex set, E is the edge set, and Lv (Le) are functions which assign each vertex (edge) a label (property). The labels can have different types, ranging from numbers (integer/float), to strings, to complex types, such as tuples, sets, or even a table. In other words, each vertex may contain additional sets of information Lv, which can be represented as attributes. For instance, in a social network, each vertex corresponds to a user and the graph database may contain many users' attributes, including age, weight, gender, etc. Similarly, each edge can also associate a set of attributes.

In SuperGraphSQL, GRAPH VIEW is introduced to facilitate the access of functionality in graph process engine. It also allows the use of SQL to explicitly model and manage the graph data. Specifically, a GRAPH VIEW represents the relational representation of a graph Q, which is essentially a view building on top of two relational tables: a vertex table (VERTEXTABLE), which records vertex set V and its corresponding attributes, and an edge table (EDGETABLE), which records edge set E and its corresponding attributes. In addition, considering some functions only need to be performed on either VERTEXTABLE or EDGETABLE (not necessarily both), the GRAPH view also needs only one of them. Moreover, SuperGraphSQL treats both VERTEXTABLE and EDGETABLE internally as a virtual view. Thus, any update to the original tables can be directly cascaded into the graph view. Finally, the keywords CREATE GRAPH VIEW is used to create such a graph view:

CREATE GRAPH VIEW FlightConnection
WITH VERTEXTABLE(Airport AS
VERTEX) AS SELECT * FROM
AirportTable
   EDGETABLE(Departure AS STARTVERTEX, Arrival AS ENDVERTEX) AS SELECT * FROM FlightTable

In this example, for illustrative purposes, assume the relational DBMS has two tables. The first one is AirportTable, which includes the detailed information of each airport in the world: AirportTable(Airport, City, State, Country, Continent, TimeZone, Latitude, Longitude, Altitude, etc.); Another is FlightTable which records all the detailed schedule information for each flight: FlightTable(Departure, Arrival, Distance, DepartureTime, ArrivalTime, Airline, FlightNumber, TravelTime, Price, etc.). In the above examples, the keywords VERTEX, STARTVERTEX, ENDVERTEX are used for explicitly specifying the attributes corresponding to vertices and edges (start vertex and end vertex). Without the explicit definition, the first column in the vertex table corresponds to VERTEX; and the first two columns in the edge table correspond to STARTVERTEX and ENDVERTEX. Thus, the creation of the graph view can be simplified as:

CREATE GRAPH VIEW FlightConnectionT
WITH VERTEXTABLE(Airport AS VERTEX) AS AirportTable
   EDGETABLE(Departure AS STARTVERTEX, Arrival AS ENDVERTEX)
AS FlightTable

Inside of the ( ), attributes may simply be renamed. However, there may be a list of attributes from each table that should be selected. In this case, the attributes for each table can be selected.

CREATE GRAPH VIEW FlightConnection
WITH VERTEXTABLE AS AirportTable(Airport AS VERTEX, City)
   EDGETABLE AS FlightTable(Departure AS STARTVERTEX, Arrival AS ENDVERTEX)

In this example, only the attributes inside of the square bracket will be selected in the graphs. It corresponds to the following complete format:

CREATE GRAPH VIEW FlightConnection
WITH VERTEXTABLE(Airport AS VERTEX)
   AS SELECT Airport, City FROM AirportTable
   EDGETABLE(Departure AS STARTVERTEX, Arrival AS ENDVERTEX)
   AS SELECT Departure, Arrival FROM FlightTable

Assuming one is only interested in traveling though the airports in North America and Europe, one can construct a graph including only airports in North America and Europe:

CREATE GRAPH VIEW FlightConnection
WITH VERTEXTABLE(Airport AS
VERTEX) AS SELECT *
   FROM AirportTable
   WHERE Continent=NorthAmerica OR Continent=Europe
EDGETABLE(Departure AS STARTVERTEX, Arrival AS ENDVERTEX) AS SELECT *
FROM FlightTable

Arbitrary valid SQL queries (including joining multiple tables, using grouping, UNION and other SQL operators and functions) can be used to define the VERTEXTABLE AND EDGETABLE when creating a graph view. Finally, note that the update of graph view is straightforward as the users can directly update (insert, delete, modify) the original tables, such as AirportTable and FlightTable, and such update can be directly reflected in the VERTEXTABLE and EDGETABLE.

Temporal Graphs:

Due to the importance of the dynamic graphs, SuperGraphSQL introduces the TEMPORAL GRAPH view. If a graph view is a temporal graph, then each record (vertex/edge) in the VERTEXTABLE and EDGETABLE will be associated with a valid time period <valid-start-time, valid-end-time>. Specifically, an insertion to the VERTEXTABLE or EDGETABLE will be automatically associated with a valid time period <currentestamp, FOREVER>. For example, users u1 and u2 become friends at time T1, then the friends table will have a row <u1, u2, <T1, FOREVER>>. A deletion of an edge or vertex will not physically delete the specified row, but instead the system will “close” the time period of the specified row. For example, if users u1 and u2 remove the friendship at T2, then the original row <u1,u2,<T1, FOREVER>> will be updated by the SuperGraphSQL to <u1,u2,<T1,T2>>. By doing this, the SuperGraphSQL system can easily answer questions like who are the friends of u1 between T1 and T2, and what was the shortest path between u1 and u2 between T1 and T2.

There are bitemporal or even three-dimensional temporal semantics discussed in the research community. However SuperGraphSQL adopts the one-dimensional temporal semantics because the one-dimensional semantics covers the important aspects of graph ananlytics whereas the bitemporal or 3 or 4 dimensional temporal semantics are too complicated for wide adoption in graph analytics. In addition, in order to support temporal graphs, SuperGraphSQL requires both VERTEXTABLE and EDGETABLE correspond to physical tables instead of SQL statements (or views). Using physical tables make associating an additional time dimension with each record in the VERTEXTABLE or EDGETABLE easier.

Next, consider the running example where additional flight can be added in the FlightTable, and new airports can be added in the AirportTable. Using the keywords TEMPORAL GRAPH VIEW, one can construct the temporal graph:

CREATE TEMPORAL GRAPH VIEW FlightConnection
WITH VERTEXTABLE(Airport AS VERTEX) AS AirportTable EDGETABLE(Departure AS STARTVERTEX, Arrival AS ENDVERTEX) AS FlightTable

Here, each airport and flight is associated with a valid time interval. Especially, using the temporal graph, one can easily access the graphs at different time snapshot using the format of GraphName[T1, T2], where T1 and T2 are the starting time point and end time point of interested interval. Other reserved keywords include: TODAY, YESTERDAY, THIS WEEK (MONTH, QUARTER, YEAR), and LAST WEEK (MONTH, QUARTER, YEAR) to describe frequently used time intervals.

Spatial Graphs, and Spatio-Temporal Graphs: As mentioned before, many (social) networks are associated with location information, i.e., users can check-in certain locations and two people can meet at a location. These spatial networks can be further integrated with temporal dimension to produce spatio-temporal graphs. Since SuperGraphSQL is based on SQL and Relational DBMS, which have provided native spatial data support, SuperGraphSQL can directly adopt spatial data in the graphs. For instance, each user (vertex) and each relationship (edge) can have spatial attributes, like Geo-location (X,Y), and a rich set of functions can then be used to query such spatial or spatio-temporal graphs.

Note that existing native graph databases do not provide direct support on either temporal or spatial data. Thus, users have to manually construct the temporal and spatial attributes and develop code to process them. In SuperGraphSQL, the modeling, representation, storage, and query these types of graphs are very intuitive and easy to use.

Heterogeneous Graphs

The above discussion on graph view considers only the “homogenous” graph where all vertices and edges belong to the same type. However, many real world applications need to be modeled as heterogeneous networks, where a vertex or an edge can have different types, and each type can consist of different attributes.

SuperGraphSQL provides natural support for heterogeneous graphs. Below is a Hospital Monitoring example to describe the heterogeneous graphs. In a hospital, the location of each individual (doctors, nurses, staffs, administrators, patients, visitors) will be monitored: which rooms they have visited and for how long. Similarly, the location information for each piece of equipment is also recorded. The entire building is decomposed into individual rooms and areas (aisles, lobby, etc.). An example problem is to discover all individuals who might have been affected if some equipment has a malfunction or is contaminated with some contagious virus. Now, assume there are the following base tables to describe individuals and equipment.

Personnel (ID, Name, Position);

Patient (ID, Name, Age, . . . );

Equipment (ID, Name);

Area (ID, AreaID, Location);

PatientUseEquipment (ID, EquipmentID, TimeInterval);

EquipmentLocation (ID, AreaID, TimeInterval);

PersonnelLocation (ID, AreaID, TimeInterval);

PatientLocation (ID, AreaID, TimeInterval)

Here, the Personnel table records every person who works in the hospital. This includes doctors, nurses, administrators, staff members, etc. The Patient table records the basic information of each patient. The Equipment table records the equipment information for each item of equipment. The Area table records each room and areas (aisles and stairs) in the hospital.

The PersonnelRelation table records the relationship between any two persons who work in the hospital. The PatientCare table records each person (doctors, nurses, and staff members) who works in the hospital and who has served a patient. The PatientUseEquipment table records which equipment a user has used at what time. The EquipmentLocation and PersonnelLocation (PatientLocation) record every room (area) a piece of equipment and a hospital personnel (patient) has visited, and at what period of time.

Given these definitions, a graph view can be created, which consists of personnel, patient, equipment, and area information as of the current day.

CRATE GRAPH VIEW
Hospital WITH
VERTEXTABLE
   AS (SELECT ID AS VERTEX,Name, ‘Personnel’ AS TYPE FROM Personnel UNION
   SELECT ID AS VERTEX,Name, ‘Patient’ AS TYPE FROM Patient UNION
   SELECT ID AS VERTEX,Name, ‘Equipment’ AS TYPE FROM Equipment UNION
   SELECT ID AS VERTEX, ArealD AS Name, ‘Area’ AS TYPE FROM Area) EDGETABLE
AS (SELECT ID1 AS STARTVERTEX, EquipmentID AS ENDVERTEX, TimeInterval, ‘Patient’ AS STARTVERTEXTYPE, ‘Equipment’ AS ENDVERTEXTYPE FROM PatientUseEquipment WHERE Contains(TimeInterval, TODAY) UNION
   SELECT ID AS STARTVERTEX, ArealD AS ENDVERTEX, TimeInterval,
      ‘Equipment’ AS STARTVERTEXTYPE, ‘Area’ AS ENDVERTEXTYPE FROM EquipmentLocation WHERE Contains(TimeInterval, TODAY) UNION
   SELECT ID AS STARTVERTEX, ArealD AS ENDVERTEXT, TimeInterval,
      ‘Personnel’ AS STARTVERTEXTYPE, ‘Area’ AS ENDVERTEXTYPE FROM PersonnelLocation WHERE Contains(TimeInterval, TODAY) UNION
   SELECT ID AS STARTVERTEX, ArealD AS ENDVERTEXT, TimeInterval, ‘Patient’ AS STARTVERTEXTYPE, ‘Area’ AS ENDVERTEXTYPE FROM PatientLocation WHERE Contains(TimeInterval, TODAY))

One may simply create the graph view as follows (without considering the WHERE constraint):

CRATE GRAPH VIEW
Hospital WITH
VERTEXTABLE
   AS Personnel(1D AS VERTEX,Name, ‘Personnel’ AS TYPE),
      Patient(ID AS VERTEX,Name, ‘Patient’ AS TYPE),
   Equipment(ID AS VERTEX,Name, ‘Equipment’ AS TYPE, FROM Equipment), Area(ID AS VERTEX, ArealD AS Name, ‘Area’ AS TYPE)
   EDGETABLE
   AS PatientUseEquipment(ID1 AS STARTVERTEX, EquipmentID AS ENDVERTEX, TimeInterval,
      ‘Patient’ AS STARTVERTEXTYPE, ‘Equipment’ AS ENDVERTEXTYPE), EquipmentLocation(ID AS STARTVERTEX, ArealD AS ENDVERTEX, TimeInterval,
‘Equipment’ AS STARTVERTEXTYPE, ‘Area’ AS ENDVERTEXTYPE), PersonnelLocationdD STARTVERTEX, ArealD AS ENDVERTEXT, TimeInterval,
‘Personnel’ AS STARTVERTEXTYPE, ‘Area’ AS ENDVERTEXTYPE), PatientLocation(ID AS STARTVERTEX, ArealD AS ENDVERTEXT, TimeInterval,
‘Patient’ AS STARTVERTEXTYPE, ‘Area’ AS ENDVERTEXTYPE)

Note that the VERTEX, TYPE, EDGETYPE, STARTVERTEXTYPE, ENDVERTEXTYPE are also reserved keywords in SuperGraphSQL.

SuperGraphSQL: Graph Analytics in SQL Language

SuperGraphSQL offers powerful supports on graph analytics. Graph analytics cannot in general be described in standard SQL. SuperGraphSQL enables various graph analytics through a simple user-friendly “function” interface. For high performance and large-scale graph analytics, SuperGraphSQL contains a specialized graph analytics engine that can leverage both distributed-memory and shared-memory parallelization to scale massive graph processing. The underlying parallelization model is based on BSP (Bulk-Synchronous Parallel) model. SuperGraphSQL not only contains a rich set of build-in graph analytics functions, but also is extensible: it provides an easy to use programming interface to allow users to develop new customized graph analytics. In the next two sections, a description will be provided about the native graph access interface and the powerful graph-processing engine. In this section, focus is on how to utilize SQL to perform graph analytics using graph view denned in SuperGraphSQL.

Graph Analytics on Graph View

The basic format to access those build-in or customized graph analytic functions in the graph engine is by using the keyword GRAPH_ENGINE and followed by the function name. Basically, GRAPH-ENGINE.function takes a graph view name as the first parameter, and the rest are the “normal” parameters to the function. The SuperGraphSQL system can automatically recognize the graph analytics and invoke the corresponding graph analytic functions in the graph analytics engine with the appropriate parameters. The following example graph function outputs the shortest paths from Cleveland international airport (CLE) to Athens international airport (ATH). It may be appreciated that the following example graph function can be incorporated with several other SQL functions. When incorporated with other SQL functions, the graph function will be communicated to the graph analytics environment when the graph function is encountered in the relational analytics environment.

SELECT * FROM
GRAPH_ENGINE.ShortestPath(FlightConnection,‘CLE’,‘ATH’)

Many graph analytic functions need additional properties associated with vertices or edges. In this example, the distance between the two airports is needed for measuring the shortest paths. In SuperGraphSQL, those attributes are referred to as VERTEXVALUE or EDGEVALUE. If there are several such attributes, they are referred to as VERTEXVALUE 1, VERTEXVALUE2, etc., and EDGEVALUE 1, EDGEVALUE2, etc. By default, SuperGraphSQL chooses the first column in VERTEXTABLE (excluding the VERTEX column) as VERTEXVALUE, and the first column in EDGETABLE (excluding both STARTVERTEX and ENDVERTEX columns) as the EDGEVALUE. If there are several attributes, the columns in VERTEXTABELE (EDGETABLE) excluding VERTEX (STARTVERTEX and ENDVERTEX) columns are ordered as VERTEX-VALUE1 (EDGEVALUE1), VERTEXVALUE2 (EDGEVALUE2), etc. based on their original order in the VERTEXTABLE (EDGETABLE). In the last example, since the Distance attribute is the first attribute next to STARTVERTEX and ENDVERTEX, the shortest-path function in the graph engine will automatically choose it as the EDGEVALUE.

Assuming there is interest in finding the shortest flight time from CLE and ATH, one can change the EDGEVALUE to the FlightTime attributes in the EDGETABLE (FlightTable). In this case, an additional parameter is added into the parameter list: EDGEVALUE=FlightTime, which indicates that the EDGEVALUE corresponds to FlightTime. Since a name is explicitly associated with the parameter, the order of the parameter can be arbitrary. One can also add GRAPH before FlightConnection, i.e., GRAPH=FlightConnection and add PARAMETER before ‘CLE’ and ‘ATH’. However, the relative order of the PARAMETER is important because the first one corresponds to departure airport and the second corresponds to the arrival airport. As in most programming languages, the meaning and/or order of parameters to a graph analytical function in SuperGraphSQL is typically specific to that function and defined/required/documented by the function implementor.

SELECT * FROM
GRAPH_ENGINE.ShortestPath(GRAPH:FlightConnection,‘CLE’,‘ATH’, EDGEVALUE=FlightTime)

The following query illustrates the usage of temporal graph in the graph analytics. It computes the shortest path from Cleveland to Athens as of last week.

SELECT * FROM
Graph_Engine.ShortestPath(FlightConnection[LASTWEEK],‘Cleveland’,‘Athens’)

It may be appreciated that the foregoing shortest path function or any other graph function may be incorporated with other SQL functions. When these graph functions are incorporated with other SQL functions, the relational analytics environment that processes the SQL functions will identify the graph functions and communicate the graph functions to the graph analytics environment.

In the past, there have been several research efforts in extending SQL to describe path discovery or subgraph matching in the relational DBMS. SuperGraphSQL provides a simple yet powerful query mechanism to enable users to discover desired paths or subgraphs by providing the built-in RegularPathExpression and SubgraphMatching functions. In addition, both functions can easily scale to massive graphs by leveraging the parallelization provided by the graph-processing engine.

SELECT * FROM
GRAPH_ENGINE.RegularPathExpression(FlightConnection,‘CLE’,‘ATH’, {(Airline=USAirway Airline=BritishAirway)*})
SELECT * FROM
GRAPH_ENGINE. SubgraphMatching(FlightConnection, {(Cleveland,?), (?,Paris), (Paris,Athens), (Athens,Cleveland)})

The first query in the above examples tries to discover a flight route from Cleveland to Athens using either USAirway or BritishAirway. The Airline is used to explicitly inform SuperGraphSQL, which attribute is used for the specific constraint. If this is not explicitly specified, the RegularPathExpression can automatically search across all the attributes. The next query, using the subgraph matching function, tries to find a flight route from Cleveland to Paris using any intermediate city, and then to Athens, and then a direct flight from Athens to Cleveland. Note that that here the constraint is based on the city names instead of the airport name. The SubgraphMatching can automatically cross link the VERTEXTABLE attributes with the EDGETABLE for this purpose.

Combining Relational Analytics and Graph Analytics

SuperGraphSQL can combine relational analytics and graph analytics in a seamless way. First, any graph processing result is a relational table and can be accessed for further relational analysis. For example, assume the ShortestPath returns the set of tuples describing the actual itinerary:

(CLE, JFK)

(JFK, CDG)

(CDG, ATH)

Then the following SQL query will join the graph analytic results with another relational table citi.info to provide best hotel and weather forecast information.

SELECT Citi_info.city, Citi_info.hotel, Citi_info.weather FROM Citi.info,
AirportTable,
GRAPH_ENGINE.ShortestPath(FlightConnection,‘Cleveland’,‘Athens’)AS Itinerary WHERE Itinerary.Departure=AirportTable.Airport and AirportTable.City=Citi_info.city

Another powerful mechanism in SuperGraphSQL is the input parameters to be table or table columns, which effectively enables the batch processing of graph analytics function. For instance, the following query returns the shortest travel time from any city to ‘Athens’:

SELECT
Citi_info.city,GRAPH_ENGINE.ShortestPathDistance(FlightConnection, Citi_info.city, ‘Athens’) FROM Citi.info, FlightConnection

Note that in order to utilize any graph analytic function from GRAPH_ENGINE in the SELECT clause, that function has to return a single value for the specified input parameters. This is to be consistent with the SQL standard. Here, the graph processing function GRAPH.ENGINE.ShortestPath is treated as a simple scalar function. SuperGraphSQL will automatically search through each cell in Citi.info.city and perform the shortest path computation. One can add more complex relational analytics to the above query, for instance in the WHERE clause:

SELECT
Citi.info.city,GRAPH_ENGINE.ShortestPathDistance(FlightConnection, Citi_info.city, ‘Athens’) FROM Citi_info, FlightConnection
WHERE Citi_info.city LIKE ‘%land’ or
   Citi_info.city in (SELECT cities FROM VoteBestCitiesTAble) or CitiTable.continent=‘America’

If one is interested in finding out the detailed itinerary instead of only the travel time, one can write the following query:

SELECT Itineary.*
FROM Citi_info, GRAPHENGINE.ShortestPath(Flightconnection, Citi_info.city, ‘Athens’) AS
Itinerary WHERE Citi_info.city LIKE ‘/.land’ 0r
   Citi_info.city in (SELECT cities FROM VotedBestCitiesTAble) or CitiTable.continent=‘America’

Graph Analytics on Relational Table:

In SuperGraphSQL, any graph analytic function can be directly applied to any relational table without creating the graph view as long as appropriate attributes are provided. For instance, one can directly find either the shortest path or the distance from one airport to another using the relational table FlightTable. The following three examples show that one can use FlightTable to replace the graph view FlightConnection in the earlier queries to access graph analytics. From this perspective, SuperGraphSQL can directly perform graph analytics on relational tables (no explicit graph view creation is first required).

SELECT * FROM
GRAPH_ENGINE.ShortestPath(FlightTable,‘CLE’,‘ATH’)
SELECT * FROM
   GRAPH_ENGINE.RegularPathExpression(FlightTable,‘CLE’,‘ATH’, {(Airline:USAirwayI Airline:BritishAirway)*})
SELECT Citi_info.city, Citi_info.hotel, Citi_info.weather FROM Citi_info, AirportTable,
   GRAPH_ENGINE.ShortestPath(FlightTable,‘Cleveland’,‘Athens’) AS Itinerary WHERE
   Itinerary.Departure=AirportTable.Airport and
   AirportTable.City=Citi_info.city

Note that in many graph analytics there is a need for both the VERTEXTABLE and the EDGTABLE. In those cases, the graph view must be created first to perform those analytics. Especially, for heterogeneous graphs, it in general needs to create the graph view first before accessing the desired graph analytics.

Materialized Graph View and Graph Indexing

Since the GRAPH VIEW is only the relational representation of a graph, when a graph analytic function is issued, currently in the implementation the following process takes place for executing the function in the graph processing engine: 1) SuperGraphSQL first dynamically loads the relational data referenced in the graph view and transfers it to the graph engine; 2) the graph engine transforms it into the native graph format; 3) if a distributed computing environment is available for SuperGraphSQL, the entire graph will be partitioned and distributed for parallel processing. Clearly, such a preparation for executing a graph analytic function introduces overhead.

SuperGraphSQL introduces the materialized graph view or graph materialization feature for reducing the cost of online loading, transformation, partition, and distribution. Using the graph materialization, these steps are performed when the graph view is created or when the materialization is added into the graph view. Specifically, when CREATE GRAPH VIEW is used, an option WITH MATERIZATION can be used to inform SuperGraphSQL that the current graph view shall be materialized. In the following example, a materialized graph view will be created and will be partitioned/distributed if there is a distributed computing environment:

CREATE GRAPH VIEW FlightConnection
WITH VERTEXTABLE(Airport AS VERTEX) AS AirportTable EDGETABLE(Departure AS STARTVERTEX, Arrival AS ENDVERTEX) AS FlightTable WITH MATERLIZATION

For certain graph queries, such as reachability or distance query, various graph indices have shown to be able to speed up the query processing. SuperGraphSQL allows users to construct graph indices (build-in or customized) for different graph queries. Especially, since building indices can be quite computationally expensive and needs to access the native graph format, SuperGraphSQL utilizes the graph processing engine to develop the built-in or customized graph indices, which can automatically leverage the shared-memory or distributed memory parallelization. Similar to the graph materialization, there is an option in graph view creation to build additional graph indices:

CREATE GRAPH VIEW FlightConnection
WITH VERTEXTABLE(Airport AS VERTEX) AS AirportTable EDGETABLE(Departure AS STARTVERTEX, Arrival AS ENDVERTEX) AS FlightTable WITH MATERLIZATION WITH INDEX(QUERYTYPE=Distance, INDEXTYPE=2H0P, KEY=EDGETABLE.Distance) AS Index1

In this example, a graph index, referred to as Index1, is added to the graph view for answering Distance query (specified by QUERYTYPE) using the index method 2HOP where the edge weight is on the Distance column in the EDGETABLE. Note that there maybe multiple graph indices as different graph queries can have different indices. In addition, SuperGraphSQL allows users to add or delete graph indices from the graph view:

DROP Index1 FROM FlightConnection
ADD INDEX(QUERYTYPE=Distance, INDEXTYPE=3H0P, KEY=EDGETABLE.Distance) Index2 TO FlightConnection

When VERTEXTABLE and EDGETABLE are modified, the materialization or index may need to be automatically updated once the change is committed. To achieve that, SuperGraphSQL introduces the keyword CASCADE to specify that the materialization and the indices should be updated for the graph change:

CREATE GRAPH VIEW FlightConnection
WITH VERTEXTABLE(Airport AS VERTEX) AS AirportTable EDGETABLE(Departure AS STARTVERTEX, Arrival AS ENDVERTEX) AS FlightTable WITH MATERLIZATION
WITH INDEX(QUERYTYPE=Distance, INDEXTYPE=2H0P, KEY=EDGETABLE.Distance) AS Index1 WITH CASCADE

Without the CASECADE option, any change to the base table used in defining the graph view will not automatically cascade into the materialized graph view and the graph indices. SuperGraphSQL allow users to manually request the update of the corresponding materialized graph views and graph indices using keywords GRAPH UPDATE:

GRAPH UPDATE FlightConnection

SuperGraphSQL: Native Graphs

Typed and Typeless Vertex and Edge Support

For applications that prefer a native style of graph API, SuperGraphSQL supports a native style of graph API based on explicit notation of vertices and edges, which is similar to the existing native databases. What makes SuperGraphSQL unique is that it supports both typed and typeless vertices and edges in a single graph. Recall that each vertex(edge) in a graph can have different types, where each type has different attributes. However, in many real world applications, the types and their properties of vertices and edges may not be well-defined when the graph is being created. In other words, the full schema of the graph (its vertices or edges) either does not exist (not available) or its schema tends to change significantly over the time. Indeed, one major motivation of the NoSQL movement is to address such a challenging problem.

Several existing graph databases use the key-value pair notation to store the property information associated with vertices and edges. In these databases, there are no explicit types of vertices and edges. Instead, the vertex and edge properties can be maintained in a key-value store or similar data structures. Though this is very flexible, its performance is often slower than the ones with known schema. This is because the known graph schema (vertex types and edge types), can enable the usage of explicit variables (to annotate each property), which can be much more efficient than accessing the key-value store. In addition, the relational table (each column corresponds to a property) can also be utilized for storing and performing relational analytics.

SuperGraphSQL is designed to achieve the best tradeoff between the flexibility of no schema and the performance of using schema. In the native graph management of SuperGraphSQL, each vertex (and edge) belongs to a type (a class), which can consist of known properties (without the explicit inheritance of the basic vertex and edge class, no property is needed to create a vertex or an edge), and each also associates with a key-value pair store for adding or removing attributes. Basically, in SuperGraphSQL, any vertex (edge) can be both typed and typeless: if the type information is known, SuperGraphSQL enables the users to specify the properties in order to maximize the performance; if the type information is not known when creating the vertices, users can simply utilize the key-value store for managing properties; if some properties are known and additional properties maybe added, the known properties can be managed through member variables through vertex/edge class and other properties can be managed through the key-value store. Furthermore, since some attributes may not be available for certain vertex/edges even if they belong to the same type (referring as data sparsity), and some attributes can be used more often than other attributes, the native graph interface in SuperGraphSQL provides the flexibility to deal with these issues: the key-value store can help with the data sparsity problem and the explicit member variables can be treated as the “cache” to speed up the property access and processing.

The following example Java application creates a graph and adds a few nodes and edges to the graph. Especially, this example demonstrates the flexibility offered by SuperGraphSQL in terms of manage typed (and typeless) vertices and edges. The Person is a typed vertex, which consists of (at least) one attribute to store a person's name. An additional attribute ‘work’ is added to Person u1 and additional attribute ‘study’ is added to Person u2. Node n1 does not have any property initially, but is provided with a type name ‘Song’. Then, a property ‘name’ is added to describe the node n1. CallEdge is a typed class, and its Property ‘length’ is set to be ‘10m’. Edge e1 does not contain any known property and is annotated as type ‘Like’. An additional key-value pair (‘buy’, ‘iTune’) is added to edge e1 to describe its property and corresponding content. Note that to facilitate the processing, SuperGraphSQL allows the key-value pair access to the membership variable as well. For instance, assuming CallEdge has a property (member variable) length, SuperGraphSQL allows access it using the key-value pair method, such as calledge.setProperty(‘length’, ‘10m’).

```
  Java example class creating graph/nodes/edges import
com.supergraphsql.*;{
  public static void main(String[ ] args) {
  String graphDBName = “SocialGraph”;
  Graph userGraph = GraphEngine.createGraph(graphDBName); Person
  u1=new Person(‘john’); Person u2=new Person(‘smith’);
  userGraph.addVertex(null, u1); userGraph.addVertex(null, u2);
  u1. setProperty(‘work’,‘GraphSQL’);
  u2.setPropertyCstudy', ‘KSU’);
  Vertex n1=userGraph.addVertex(null, ‘Song’); //Type of the Node is
  ‘Song’
  n1.setProperty(‘name’, ‘BreakAway’);
  n1.setProperty(‘singer’, ‘Kelly Clarkson’);
  CallEdge calledge= new CallEdge(null, u1,u2,‘2010-10-24’);
  userGraph.addEdge(calledge); calledge.setProperty(‘length’, ‘10m’);
  Edge el=userGraph.addEdge(null, u1.n1,‘Like’); //Type of the Edge is
  ‘Like’
  el.setProperty(‘buy’, ‘iTune’);
```

Note that the native graph interface in SuperGraphSQL is a superset of Blueprints API, which attempts to provide a common native graph API such that any tool written in Blueprints API can work over various graph database vendors. Thus, users in SuperGraphSQL can also access a list of available graph processing tools, such as Pipes and Gremlin. Also, users can develop applications using the native graph based graph API and access the graph analytics described in the graph processing engine, which will be described in the next section.

Relational Analytics Over Graphs

Uniquely in SuperGraphSQL, any native graph has a corresponding relational representation in the relational DMBS. Specifically, SuperGraphSQL actually stores each native graph in two table views, a VERTEXTABLE and an EDGETABLE; and vertices of different types are stored in separate tables. Basically, graphs can be treated as relations in SuperGraphSQL. Thus, in SuperGraphSQL, SQL relational analytics can be easily applied to native graphs. Furthermore, the (native) graph and the relational tables can be joined together and combined for powerful analytic tasks.

In the earlier example, SuperGraphSQL stores two tables: a SocialGraph-VERTEX table view and a SocialGraph-EDGE table view. The vertex table view has a vertexid column, and a column for each attribute in the corresponding Java node class. Similarly the SocialGraph.EDGE table view has two columns corresponding to the two vertices connected, and also a column for each attribute in the corresponding Java Edge class. Furthermore, each key in the key-value store will serve as a unique column in the vertex or edge table. In addition, there are four actual tables: two vertex tables, SocialGraph-VERTEX-Person for Person class, SocialGraph-VERTEX Song for ‘Song’ type; two edge tables, SocialGraph-EDGE-CallEdge for CallEdge class and Social-Edge-Like for ‘Like’ type. The following SQL query computes how many phone calls each person got between ‘2000-10-10’ and ‘2001-10-09’ on the SocialGraph created in SubSection 6.1.

//computes the total number of vertices in the SocialGraph
SELECT COUNT(*)
FROM SocialGraph_VERTEX
//computes the total number of edges in the SocialGraph SELECT
COUNT(*)
FROM SocialGraph_EDGE
//compute the 100 Person who have the most edges.
SELECT Person.vertexid_1, COUNT(*) as totalEdges FROM
SocialGraph_EDGE_Person AS Person GROUP BY Person.vertexid_1
ORDER BY totalEdges LIMIT 100

Note that users can write equivalent Java/C programs to navigate the graph to compute the same results. However, writing/compiling/debugging the Java/C programs is time consuming, prone to errors, hard to share/maintain/reuse. For example, the above SQL can be easily enhanced by an “order by” clause to sort the results to get top K most/least called persons.

Joining Relations/Graphs with Graphs: A key tool in the relational DBMS is the joining operation, which can be critical for many computational tasks. Since SuperGraphSQL provides the relational representation of the native graphs, users can perform join operation between any relational table with graphs, or even join two graphs (generally assuming they share some common vertices).

//Compute the fan population for each singer
SELECT Song.singer, COUNT(DISTINCT Like.vertexid_1)
FROM SocialGraph_EDGE_Like AS Like,
SocialGraph.VERTEX_Song AS Song WHERE
Like.vertexid_2=Song.vertexid
GROUP BY Song.singer

In the above example, the Like edge table is joined with the Song vertex table to count the total number of fans for each singer. Writing this procedure in Java or any existing native graph database needs to perform graph traversal and it is very computational expensive. However, such a task is easy to describe in SQL and can be performed efficiently.

SuperGraphSQL: Graph Analytic Engine

The design of SuperGraphSQL aims to handle massive graphs with millions or billions of vertices and edges. Though the relational DBMS has no problem to store large graphs at this scale, processing graphs at this scale is notoriously hard. SuperGraphSQL leverages an enhanced BSP (Bulk-Synchronous Parallel) model to enable analyzing massive graphs on powerful parallel computing platforms; both distributed memory clusters and/or (shared-memory) multi-core machines, and their combination can all be supported to scale graph processing. The basic BSP model targeted a set of computational unit (machines, processors) connected by a communication network. A BSP computation proceeds with a series of coordinated supersteps. Each superstep generally consists of three stages and is performed on each individual computational unit:

(Computation Stage): each machine performs independently certain computation on their own without exchanging any message; each uses only the data stored locally and possibly message received from other machines.

(Communication Stage): each machine communicates with others by sending data or computational results.

(Barrier Synchronization): when a machine finishes the last two stages and it reaches the barrier point to synchronize, i.e. to wait until all other processes to reach this point.

To apply BSP on massive data processing, a key issue is how to partition the entire dataset and distribute the partitions to the individual machines to allow them to perform the coordinated superstep computation. In the graph processing scenario, to apply BSP, one needs to partition the graph into different parts (the parts could be overlapped). The underlying issue of graph partition is that since any graph traversal is involved with accessing the neighbors of a given node, if two nodes are not assigned to the same machine, these two machines are likely to communicate with one another. Generally, the more these nodes are split by partitioning, the more communication is needed during the superstep, and the more local computation maybe needed. This is because more redundant computation maybe introduced and the number of supersteps may also increase for finer partition due to the lack of global knowledge. Load balancing is another major problem in BSP computation. If a machine is overloaded in run-time, there may be a need to dynamically migrate certain data (vertices/edges in the graph) and their computational task to other machines. However, dynamic load balancing can be hard as it can be very difficult to determine and map the data (vertices) with its corresponding computational memory/intermediate results. Finally, in graph analytics processing, basic and important primitives have to be provided to effectively deal with the underlying graphs and traversing the graphs.

To solve the aforementioned problems in SuperGraphSQL, SuperGraphSQL utilizes a novel SuperNode scheme to adopt the BSP graph analytics computation. Simply speaking, a supernode corresponds to a group of vertices in the targeted graph. For each vertex in a supernode, it maintains two separate lists of edges (for undirected graph): SuperNodeEdge records those edges with both ends in the supernode, and BridgeEdge records those edges with one edge in this supernode and another end in another supernode. For the directed graphs, each vertex has four lists of edges: SuperNodeInEdge, SuperNodeOutEdge, BridgeInEdge and BridgeOutEdge, where In and Out indicate the direction of the edges with respect to the vertex. Each supernode can perform superstep computation on its own data (vertices and edges).

Each supernode has the flexibility of accessing any vertices that belong to it and thus there is no need for message passing between any vertices in the same supernode. However, to access vertices in another supernode, the supernode will reply on message passing mechanism. Note that each supernode will be distributed and executed on an individual machine. Clearly, the supernode also makes the dynamic load balancing possible as each supernode is self-contained and can be easily migrated. Furthermore, the granularity of the supernode can be customized based on different computation purposes. In two extremes, a supernode can be either a single node or have all vertices on a machine. For the former, the issue is that massive amounts of messages can be produced for large and dense graphs, as any two connected vertices are likely to communicate with one another. For the latter, it is very hard to support any dynamic load-balancing. Also, if graph partition is poor, the amount of message can still be very large. In SuperGraphSQL, a supernode is not allowed to be partitioned onto different machines and thus can force the densely connected vertices to be partitioned in one supernode and thus distributed to one machine. Therefore, the communication cost can be significantly reduced. However, how to produce the optimal supernode assignment is apart from the scope of this disclosure and SuperGraphSQL enables customization on supernode assignment for different computational purposes.

The basic superstep of a supernode contains the following steps:

1. (Computation) Any supernode which received a message is activated and performs the independent computation based on its local data (vertices and edges recorded in the supernode) and the received message;

2. (Message Passing) Each supernode sends data to its neighbor supernode (two supsernodes are neighbors if at least one vertex from one supernode is connected to the other);

3. (Barrier Synchronization) After the message passing, each supernode is stopped and waits for all other supernodes to complete their computation and message passing.

Note that in the above superstep, only when a supernode has received a new message does it need to be activated to perform new computation. Also, in the first superstep, a subset of supernode (depending on different computation tasks) will get a pseudo-message and thus can be activated to start to perform the superstep computation.

The following two subsections will overview the object class, which describes the vertex and supernode class, and will overview how to develop the code for implementing the superstep computation for a supernode. Note that in SuperGraphSQL, users can directly access these superstep computations and further analyze their computation results in the relational table format.

```
  Vertex and Super Node Classics in C++
  //Each vertex that is considered active in a superstep will be invoked for
supernode computation. Each supernode will manage the message
received by its vertices.
  template<typename VertexValue, typename EdgeValue,
    typename MessageValue> class Vertex {
  public:
    const int64 vertex_id( ) constant;
    const VertexValue & GetVertexValue0;
    VertexValue * MutableValue( ) ;
    OutEdgelterator GetOutEdgelterator( );
    Messagelterator GetMessagelterator( );
    void SendMessageTo(const stringfe dest_vertex, Messagefe
    message) ;}
  template<typename VertexValue, typename EdgeValue,
    typename MessageValue> class SuperNodeVertex:
  public class Vertex<VertexValue.EdgeValue,MessageValue> {
    int local_id( );
    //each supernode is assigned with a local_id to facilitate their
    access;
    OutEdgelterator GetSuperNodeOutEdgelterator( );
    //outgoing edges linking to other vertices in InEdgelterator
    GetSuperNodelnEdgelterator( );
    //incoming edges from other supernode; OutEdgelterator
    GetBridgeOutEdgelteator( );
    //outgoing linking to vertices outside the superno
    InEdgelterator GetBridgelnEdgelterator( );
    //incoming edges from vertices outside the supserno
  template
  <typename SuperNodeVertex> class SuperNode {
    SuperNodeVert ex *vertex; public:
      virtual void Computation ( ) = 0 ;
      int64 superstep( ) const;
      int NumberOfVertices( ); // number of Vertex in the
      SuperNode Vertexlterator GetVertexIterator ( ); //access
    each vertice;
      Vertexlterator GetActiveVertexterator( );
      received new message;
  void VoteToHalt( );
```

In at least one example, the following is how the connector works. For each graph function provided by the native graph engine there is a registration of a corresponding user defined function in the RDBMS environment. Also registered is other information about the graph environment in the SQL environment (relational environment) such as: the machine's IP address where the graph engine is running, the TCP/IP port number the graph server is listening to, the redundant graph engine server IP address and port number, or time out (the amount of time elapsed before the UDF will try the fall back graph engine if it cannot reach to the primary one or if the primary one failed to provide complete results).

When the user function is invoked such as in a standard SQL query from any RDBMS supported interface (example: select * from graphsq1_shortesthpah(graph=‘graph1’, startid=1, endid=2)), the function will communicate with the graph engine by sending the parameters to the graph server. The graph server will receive the request and run the graph function ‘shortest path’ on the graph ‘graph1’ for startingnode=1 and endnode=2. The graph server will send back the results to the UDF such as tuples below:

{1, 10} {10, 20} {20, 2}

The communication between RDBMS and Graph server uses standard TCP/IP sockets when RDBMS and graph server are on different physical machines. If they happen to run on the same physical machine, a more efficient communication mechanism called Domain Socket is used (which is very similar to TCP/IP socket). If at any time the UDF has problem getting results/response from the graph engine, after a certain amount of time set by the timeout option, the UDF will try use the fall back graph server.

Correspondingly, on the graph server side, a control thread is always listening to requests from RDMBS user defined functions (UDFs). When it receives a request, it will use another (worker) thread to execute the requested function with the passed parameters. The worker thread will check whether a requested graph is loaded in memory or not already, if yes, it will invoke the requested function (shoretestpath). If the graph is not loaded into memory yet, it will load the graph into memory (may need to discard some other graph data stored in memory which isn't being used by any graph functions at the moment). The worker thread then sends the results back to the UDF on the SQL side.

Alternatively, one can just register one generic UDF on the SQL RDBMS side (say the name is graphsq1_engine) instead of one for every graph function we provided at the graph server side. Thus instead of the following:

select * from graphsq1_shortesthpah(graph=‘graph1’, startid=1, endid=2).

We do:

select * from graphsq(function=‘shortestpath’, graph=‘graph1’, startid=1, endid=2)”.

That is when the user calls the generic UDF, the user has to provide the actual function name to be used. However, the underlying implementations for both options are the same (TCP/IP socket communication, SQL UDF pass the parameters to the graph sever for interoperation and graph function execution)

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method for facilitating a unified analytics environment (100) comprising a relational analytics environment (111) and a graph analytics environment (121), the method comprising:
within the relational analytics environment, handling a plurality of relational functions;
while handling the plurality of relational functions, encountering at least one graph function that comprises a query intended for the graph analytics environment; and
in response to encountering the at least one graph function, communicating with the graph analytics environment to handle the at least one graph function.

2. The method of claim 1, wherein the at least one graph function comprises a user defined function.

3. The method of claim 1, wherein each of the plurality of relational functions comprises a structured query language (SQL) query.

4. The method of claim 3, further comprising:
in response to the SQL query, building a graph using data from the relational analytics environment.

5. The method of claim 3, further comprising:
in response to the SQL query, using a graph analytics function to answer the SQL query.

6. The method of claim 1, wherein the at least one graph function comprises at least one shortest path function.

7. The method of claim 1, wherein the at least one graph function comprises at least one function to find certain types of nodes within a graph.

8. The method of claim 1, further comprising:
generating a response in the graph analytics environment for the at least one graph function.

9. The method of claim 8, further comprising:
communicating the response to the relational analytics environment; and
integrating the response in a table with other responses to the plurality of relational functions.

10. The method of claim 1, wherein the plurality of relational functions comprises at least one function to generate a graph from relational data in the relational analytics environment.

11. One or more computer readable storage media having program instructions stored thereon for facilitating a unified analytics environment (100) comprising a relational analytics environment (111) and a graph analytics environment (121) that, when executed by a computing system, direct the computing system to at least:
initiate a communication with the graph analytics environment to resolve a query specified by a graph function encountered while handling a plurality of relational functions in the relational analytics environment, wherein the communication identifies which graph analytics function of a plurality of graph analytics functions available within the graph analytics environment to apply;
receive a response to the communication; and
integrate the response with at least one other response to at least one of the plurality of relational functions.

12. The one or more computer readable storage media of claim 11, wherein the graph function comprises a user defined function.

13. The one or more computer readable storage media of claim 11, wherein the plurality of relational functions comprise a structured query language (SQL) query.

14. The one or more computer readable storage media of claim 13, wherein the instructions further direct the computing system to:
in response to the SQL query, build a graph using data from the relational analytics environment.

15. The one or more computer readable storage media of claim 13, wherein the instructions further direct the computing system to:
in response to the SQL query, use a graph analytics function to answer the SQL query.

16. The one or more computer readable storage media of claim 11, wherein the graph function comprises a shortest path function.

17. The one or more computer readable storage media of claim 11, wherein the graph function comprises a function to find certain types of nodes within a graph.

18. The one or more computer readable storage media of claim 11, wherein the program instructions, handling a plurality of relational functions in the relational analytics environment, direct the computing system to:
identify the graph function; and
execute the plurality of relational functions that are not the graph function.

19. The one or more computer readable storage media of claim 11, wherein the response to the communication comprises a result of the graph function.

20. The one or more computer readable storage media of claim 11, wherein the plurality of relational functions comprise at least one function to generate a graph from relational data in the relational analytics environment.

21. A method for acquiring, graphing, querying, and acting upon relational data, comprising:
acquiring data regarding a plurality of data sources; graphing said data into a graph of relational data nodes and interconnecting data edges;
sectioning said graph into sub graphs, defining super nodes in relational interconnection with other super nodes, each said super node comprising a group of relational data nodes and interconnecting data edges;
searching said sub graphs for response to a first query;
further searching relational data nodes and interconnecting data edges of sub-graphs responding to said first query for response to a second query; and
acting upon responses received from said second query.
